(19) United States
(12) Patent Application Publication
(10) Pub. No.: US 2026/0189077 A1
(43) Pub. Date: Jul. 2, 2026

(54) FOREIGN OBJECT DETECTION AND FRIENDLY METALS

(71) Applicant: Dolby Intellectual Property Licensing, LLC, San Francisco, CA (US)

(72) Inventors: Jayanti Ganesh, Bangalore (IN); Viswanathan Kanakasabai, Bangalore (IN); Subbarao Tatikonda, Bangalore (IN); Suma Memana Narayana Bhat, Bangalore (IN)

(21) Appl. No.: 19/130,043

(22) PCT Filed: Nov. 14, 2023
(86) PCT No.: PCT/US2023/079619

§ 371 Date: May 14, 2025

(30) Foreign Application Priority Data
Nov. 14, 2022 (IN) 202211065088

(51) Int. Cl. H02J 50/60; H02J 50/10; H02J 50/80; H05B 1/02; H05B 6/12

(52) U.S. Cl. CPC H02J 50/60; H02J 50/10; H02J 50/80; H05B 1/0266; H05B 6/1209

(57) ABSTRACT

This disclosure provides systems, methods and apparatuses for object detection by a Power Transmitter (PTx) that supports both induction heating and wireless power transfer. An object detection assessment is based on a measurement value obtained while the PTx transmits an object detection pulse (also referred to as an object detection signal). When the PTx determines that a Power Receiver (PRx) is present in the magnetic field of the PTx, the can also compare the measurement value to various thresholds to determine whether a foreign object is also present in the magnetic field. The various thresholds include a PRx threshold range. In some implementations, the PRx threshold range can enable the PTx to discern between a foreign object and a PRx that contains friendly metals that would otherwise be detected as foreign objects. In some implementations, an object detection assessment can be combined with a coupling factor measurement to concurrently detect for a foreign object and calculate the coupling factor between the PTx and the PRx.

### TECHNICAL FIELD

This disclosure relates generally to wireless power transfer and, in some instances, foreign object detection techniques.

### DESCRIPTION OF RELATED TECHNOLOGY

An appliance (such as a kitchen cooktop or hob) may support induction heating of an object (such as a cooking vessel or a utensil). For example, a hob may include several “burner” locations at which a user may place a cooking vessel or utensil to be heated. In a conventional hob, an electric or gas heat source is used to heat a cooking vessel in contact with the heat source. A modern hob that supports induction heating may use an electromagnetic field (without a direct heat source) to heat a cooking vessel or utensil within. The electromagnetic field may be generated by one or more coils (sometimes referred to as induction coils). During induction heating, the electromagnetic field induces a current in a metal surface of the cooking vessel or utensil. The induced current in the surface of the cooking vessel or utensil then induces even other currents (sometimes referred to as eddy currents) within the cooking vessel thereby providing heat throughout the cooking vessel.

Meanwhile, in a separate technical field, technology has been developed to enable wireless power transfer. Wireless power transfer may be referred to as a contactless power transmission or a non-contact power transmission. The wireless power may be transferred using inductive coupling or resonant coupling between a Power Transmitter (sometimes also referred to as a “wireless power transmission apparatus”) and a Power Receiver (sometimes also referred to as a “wireless power reception apparatus”). For example, the Power Transmitter may include one or more coils (referred to as a primary coil) that produces an electromagnetic field. The electromagnetic field may induce an electromotive force in a secondary coil of the Power Receiver when the secondary coil is placed in proximity to the primary coil. In this configuration, the electromagnetic field may wirelessly transfer power to the secondary coil. A Power Receiver may be included in various types of devices, such as mobile devices, small electronic devices, computers, tablets, gadgets, appliances (such as cordless blenders, kettles, or mixers), and some types of larger electronic devices, among other examples.

Because induction heating and wireless power transfer have some common components and applications within a kitchen, there is a desire to provide a multi-function hob that supports both an induction heating mode and a wireless power transfer mode. The multi-function hob may alternatively support either induction heating for one type of object (such as a cooking vessel or utensil) and wireless power transfer to another type of object (such as an appliance having a Power Receiver) depending on which type of object is present at a particular time. A third type of object (such as a key, a coin, a metallic can, or aluminum foil, among other examples) is referred to as a foreign metal object or foreign object. When the foreign object is present in the electromagnetic field, the foreign metal object may be undesirably heated up due to eddy currents. Therefore, a multi-function hob must accurately determine which type of object is present in the electromagnetic field, particularly before the multi-function hob initiates induction heating or wireless power transfer.

### SUMMARY

The systems, methods, and apparatuses of this disclosure each have several innovative aspects, no single one of which is solely responsible for the desirable attributes disclosed herein.

One innovative aspect of the subject matter described in this disclosure can be implemented as a method for wireless power transfer by a Power Transmitter, including. The method includes receiving a communication from a Power Receiver present in a magnetic field of the Power Transmitter. The method includes obtaining a measurement value based on an object detection assessment. The method includes determining whether a foreign object is present with the Power Receiver in the magnetic field based on the measurement value.

Another innovative aspect of the subject matter described in this disclosure can be implemented as a method for wireless power transfer, including. The method includes receiving a communication from a Power Receiver present in a magnetic field of the Power Transmitter. The method includes obtaining a measurement value of a low power transmission from a Power Transmitter during an object detection assessment. The method includes calculating a coupling factor between the Power Transmitter and the Power Receiver based on the measurement value, where the coupling factor represents an alignment of a primary coil of the Power Transmitter with a secondary coil of the Power Receiver.

Another innovative aspect of the subject matter described in this disclosure can be implemented as an apparatus for wireless power transfer. The apparatus includes a communication unit configured to receive a communication from a Power Receiver present in a magnetic field of the Power Transmitter. The apparatus includes a measurement unit configured to obtain a measurement value based on an object detection assessment. The apparatus includes a control unit configured to determine whether a foreign object is present with the Power Receiver in the magnetic field based on the measurement value.

Another innovative aspect of the subject matter described in this disclosure can be implemented as an apparatus for wireless power transfer. The apparatus includes a communication unit configured to receive a communication from a Power Receiver present in a magnetic field of the Power Transmitter. The apparatus includes a measurement unit configured to obtain a measurement value of a low power transmission from a Power Transmitter during an object detection assessment. The apparatus includes a control unit is configured to calculate a coupling factor between the Power Transmitter and the Power Receiver based on the measurement value, where the coupling factor represents an alignment of a primary coil of the Power Transmitter with a secondary coil of the Power Receiver.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

FIG. 1 is a conceptual diagram showing an example multi-function hob and example objects.

FIG. 2 shows a block diagram of an example wireless power transfer system.

FIG. 3 shows a flowchart diagram of an example process for an object detection assessment.

FIG. 4 is a diagram conceptually illustrating various ranges and measurement values for object detection.

FIG. 5 is a diagram conceptually illustrating a measurement value and range for a Power Receiver (PRx) with friendly metals.

FIG. 6 is a timing diagram showing a baseline scenario when a PRx with friendly metals is repeatedly detected as a foreign object.

FIG. 7 is a timing diagram showing an example scenario in which a reference value for a PRx with friendly metals can be used for a subsequent object detection assessment.

FIG. 8 is a timing diagram showing an example scenario in which a communication from a PRx with friendly metals can improve object detection assessment results.

FIG. 9 shows a block diagram of an example Power Transmitter (PTx).

FIG. 10 shows a block diagram of an example PRx with a switch to enable disconnection of a secondary coil during an object detection assessment with coupling factor measurement.

FIG. 11 shows a flowchart diagram of an example process according to some aspects of this disclosure.

FIG. 12 shows a flowchart diagram of an example process according to some aspects of this disclosure.

FIG. 13 shows a block diagram of an example apparatus for use in a multi-function hob.

Like reference numbers and designations in the various drawings indicate like elements.

### DETAILED DESCRIPTION

An apparatus (such as a multi-function hob) may support an induction heating mode (for use with some types of devices) and a wireless power transfer mode (for use with other types of devices). For example, in the induction heating mode, the apparatus may support induction heating of an induction heating device (such as a cooking vessel or utensil). In a wireless power transfer (WPT) mode, the apparatus may support wireless power transfer to a wireless Power Receiver (PRx). For brevity, this disclosure may refer to the apparatus as a Power Transmitter (PTx) because it supports the wireless power transfer mode. Furthermore, while a multi-function hob might have multiple such PTx's, the concepts of the disclosure are described in relation to one PTx and can be extended to other PTx's of the multi-function hob. The disclosed PTx may differ from a traditional PTx in that it is configured to also support the induction heating mode when an appropriate induction heating device is positioned in proximity to one or more coils of the PTx.

Because the PTx of this disclosure supports both induction heating and wireless power transfer, it is desirable to detect objects of different types that may be positioned in proximity to the one or more coils of the PTx. Examples of a first type of object may include a pots, pans, woks, or any cooking vessel or utensil for which an induction heating mode is appropriate. Any one of these may be referred to as an induction heating device. Examples of a second type of object may include mobile devices, small electronic devices, computers, tablets, gadgets, appliances (such as cordless blenders, kettles, or mixers), or any type of device that includes a PRx for which a wireless power transfer mode is appropriate. Another type of object that may be inadvertently located in an operative environment of a PTx may be referred to as a foreign object. Non-limiting examples of foreign objects may include a ferrous object, a metallic can, a coin, a metal spoon, a key, aluminum foil, or other electrically conductive or ferrous objects that are not an induction heating device or a PRx. When a foreign object (FO) is in proximity to a magnetic field of the PTx, the foreign object may interact with the magnetic field and become undesirably heated up. Thus, it is desirable to detect which type of object (an induction heating device, a PRx, or an FO) is present in an operative environment of a PTx.

Typically, the PTx will perform an object detection assessment prior to initiating induction heating or wireless power transfer. The object detection assessment can be used to detect whether an object is an induction heading device, a PRx, or a foreign object. Therefore, the object detection assessment also may be referred to as a foreign object detection procedure, a pot detection procedure, pan detection procedure, PRx detection procedure, foreign object detection procedure, or other terms. As part of the object detection assessment, the PTx might pulse a primary coil or one or more object detection coils. The PTx measures a measurement value associated with the magnetic field generated by the pulse or associated with a characteristic of the primary coil or one or more object detection coils. Examples of the measurement value (sometimes also referred to as a parameter) include a voltage, current, impedance, a quality factor, a coupling factor, a differential value (difference of measurements at two coils, such as differential voltage, differential current, or differential impedance), or any type of parameter associated with a power transmission circuit, among other examples. The measurement value also may be referred to as an object detection measurement, measured parameter, or other similar terms. The object detection assessment includes comparing the measurement value with one or more thresholds to determine the type of object in the operative environment. Thus, the object detection assessment can be used to detect the presence of an induction heating device, a PRx, or a foreign object. The PTx is configured to perform an object detection assessment before transitioning to a power transfer phase to ensure that no foreign object has been introduced in the operative environment.

In some cases, an appliance might include a PRx as well as friendly metals. Friendly metals might include conductive materials (such as a knob, a metallic shield, wire, microprocessor, or motor, among other examples) in the apparatus that are intentionally included to support the functionality or construction of the apparatus. Because of the presence of friendly metals, a PTx might perform an object detection assessment that results in a foreign object detection (FOD) fault even though the object is actually an appliance with a PRx and friendly metals. Typically, a user might clear the FOD fault by a user action, such as removing the appliance from the operative environment and returning the appliance to the operative environment to clear the FOD fault.

There may be instances in which a PRx remains in the operative environment, but occasionally transitions into and out of the power transfer phase. For example, the PRx may be in an appliance that is occasionally turned on or off by a user action, or the PRx may be programmed to receive wireless power according to a schedule. The PTx might perform a new object detection assessment before each transition to the power transfer phase. However, due to the presence of friendly metals with the PRx, the PTx might incorrectly detect the PRx and friendly metals as a foreign object and trigger an FOD fault before each transition to the power transfer phase. This can be frustrating for an end user, especially when the FOD fault is repeatedly triggered for the same PRx each time the PRx requests the PTx to transition to the power transfer phase and each FOD fault requires user interaction.

This disclosure provides systems, methods and apparatuses for object detection that accommodates a PRx with friendly metals. This disclosure includes several aspects of object detection in which user interaction can be minimized or eliminated for object detection assessments of the same PRx with friendly metals. In some aspects, a PTx can determine whether a foreign object is present in the magnetic field with a PRx based on a comparison of a measurement value with one or more threshold ranges. For example, a PRx threshold range might be based on a reference value for the PRx that contains friendly metals. Alternatively, or additionally, the reference value or the PRx threshold range might be based on a previous measurement value of a previous object detection assessment in which an object is confirmed to be a PRx with friendly metals. The PTx can store the previous measurement value as the reference value for the PRx or update the PRx threshold range when the PTx determines that no foreign object is present with the PTx in the magnetic field. When a movement of the PRx occurs, the measurement value might change. When the PTx detects a new measurement value for the PRx is due to a movement of the PRx rather than a FO, the PTx can store the new measurement value as the reference value for the PRx.

In some aspects, a PRx might communicate the reference value or a range of expected values to the PTx during a pre-power transfer phase, where the reference value or the range of expected values is based on results of an object detection assessment in a test environment when the PRx was placed on a standard test PTx and no foreign object is present. The PTx can determine the PRx threshold range based on the reference value. Alternatively, or additionally, the PRx might communicate an indication (which may be referred to as a friendly metals indication) to inform the PTx that the PRx has friendly metals, thereby causing the PTx to adjust the PRx threshold range.

In some aspects, a PRx might communicate an identification of the PRx in association with the reference value, the range of expected measurement values, or the friendly metals indication. The PTx can store the identification of the PRx in association with the reference value, the range of expected measurement values, or the friendly metals indication for the PRx.

In some aspects, an object detection assessment can be combined with a coupling factor measurement. A coupling factor (which may be referred to as K-factor) refers to a metric indicating the alignment of the primary coil of the PTx and the secondary coil of the PRx. The coupling factor is calculated based on a ratio of the voltage applied to the primary coil and a voltage measured at the secondary coil. In some aspects, the same pulse (which may be referred to as an object detection pulse) that is used for an object detection assessment can also concurrently be used for coupling factor measurement. In some implementations, the same measurement value (for a first parameter) can be used for object detection assessment and coupling factor measurement. In some implementations, a PTX can obtain a first measurement value (for a first parameter) and a second measurement value (for a second parameter) during the same object detection assessment. The PTx might use the first measurement value (such as voltage) to calculate a coupling factor, while a second measurement value (such as impedance or Q-factor) can be used for detecting a foreign object or PRx. The object detection assessment might include the PTx transmitting a pulse of energy via the primary coil. The pulse of energy may have a measured or configured voltage, referred to as a transmitted voltage. In some cases, the PTx can measure the coil current or coil impedance of the primary coil during the object detection pulse. Meanwhile, during the pulse, the PRx might measure the voltage induced on a secondary coil of the PRx as a result of the pulse. For example, the PRx might measure the voltage (which may be referred to as received voltage or induced voltage) while a switch of a power reception circuit is electrically open to obtain an accurate voltage measurement and/or to protect other components of the PRx. The PRx can communicate a received voltage value to the PTx after the pulse. The PTx can calculate a coupling factor based, at least in part, on a ratio of the received voltage value and a transmitted voltage value for the voltage of the pulse on the PTx side. The PTx obtains the same measurement value for a first parameter (such as voltage) or a different measurement value for a second parameter (such as current, impedance, quality factor, or other parameter) during the pulse and uses the measurement value for the object detection assessment.

Particular implementations of the subject matter described in this disclosure can be implemented to realize one or more of the following potential advantages. A PTx can use the techniques of this disclosure to more accurately detect various types of objects, such as an induction heating device, an appliance having a PTx and friendly metals, or a foreign object. In some cases, a PRx having friendly metals might use the techniques of this disclosure assist the PTx in detecting the PRx with little or no user interaction. The PTx can use historical information from one or more previous object detection assessments to reduce the occurrence of false-positive FO detections, thereby increasing usability of the PTx and user satisfaction. In some instances, the combination of an object detection assessment and coupling factor measurement can improve overall operation of the wireless power system.

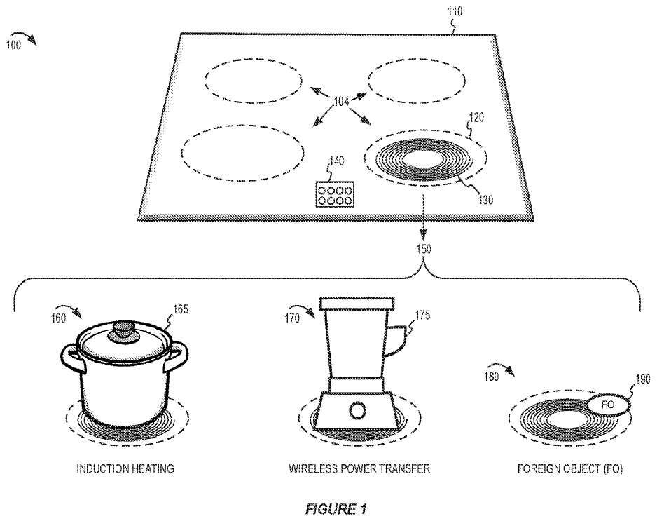

FIG. 1 is a conceptual diagram 100 showing an example multi-function hob 110 and example objects. The multi-function hob 110 may include several locations 104 for placement of objects. At least one of the locations 104 may include a PTx 120 that supports induction heating or wireless power transfer to an object when an appropriate object is placed at a location associated with the PTx 120. FIG. 1 depicts a PTx 120 at one of the locations 104. It should be understood that the multi-function hob 110 may include a PTx at more than one (or even all) of the locations 104. In such scenarios, each of the locations 104 that includes a PTx may operate in accordance with implementations described herein with reference to PTx 120. The multi-function hob 110 may include a first user interface 140 with inputs (such as knobs, buttons, or touchscreen sensors) to receive user input or to present indications to a user of the multi-function hob 110. In some implementations, the multi-function hob 110 may be referred to as a hob, a cooktop, a stove, or other term to refer to a kitchen appliance. Furthermore, while the examples described in this disclosure refer to a multi-function hob, aspects of this disclosure may be used with other types of appliances that support both induction heating and wireless power transfer. In some implementations, a multi-function hob may be portable in nature and may include a single PTx. For example, a portable multi-function hob may include a battery or be capable of an external power source to power the PTx. In some implementations, the portable multi-function hob (with one or more PTx's) may be suitable for camping.

The PTx 120 may include one or more primary coils. For brevity, this disclosure refers to the one or more primary coils as a primary coil 130—however, it should be understood that some implementations of a PTx 120 may include more than one primary coil 130. The primary coil 130 is configured to generate a magnetic field for transmitting wireless energy to an object in the magnetic field of the primary coil 130. In some implementations, the primary coil 130 may be a wire coil coupled to a driver that applies power to the primary coil 130 during either an induction heating operation or a wireless power transfer operation.

A multi-function hob 110 may provide at least one PTx 120 that can support either induction heating or wireless power transfer depending on which type of object is in proximity to the primary coil 130. The primary coil 130 may be referred to as an induction coil-particularly when the PTx 120 is used in an induction heating mode. Additionally, or alternatively, the primary coil 130 may be referred to as a power transfer coil-particularly when the PTx 120 is used in a wireless power transfer mode. For brevity, this disclosure may use the terms “apparatus” and “PTx” interchangeably to collectively refer to an apparatus that supports both an induction heating mode and a wireless power transfer mode

FIG. 1 also illustrates examples 150 of various types of objects that may be placed in the magnetic field of the primary coil 130. In the first example 160, the object may be an induction heating device 165. In the second example 170, the object may be a wireless Power Receiver (PRx) 175. In a third example 180, the object may be a foreign object 190.

Referring to the first example 160, an induction heating device 165 may be a cooking vessel, a utensil, or any other device which is intended to be heated using induction heating. During induction heating, the primary coil 130 may generate a magnetic field to transmit energy that causes eddy currents to be conducted in a ferrous or semi-ferrous surface of the induction heating device 165. The eddy currents conducted in the ferrous or semi-ferrous components of the induction heating device 165 cause the induction heating device 165 to become heated, thereby heating food or other materials placed in the induction heating device 165.

Referring to the second example 170, a device may include a PRx 175 having one or more receiving coils (sometimes referred to as a secondary coil). The PRx 175 also may have a rectifier to harvest power from the magnetic field and use the power to operate various other components of the device in which the PRx 175 is located. A PRx 175 and PTx 120 may operate in accordance with a technical standard specification that defines a communication protocol to control an amount of power transferred by the magnetic field. The PTx 120 and the PRx 175 may form a wireless power transfer system when both are present.

It should be apparent that induction heating is not the same as wireless power transfer. An aim of induction heating is to transfer energy that creates eddy currents in the induction heating device 165, while such eddy currents are undesirable in a PRx 175. An aim of wireless power transfer is to transfer energy that creates electromagnetic potential in a secondary coil that can be harvested for powering components of the device which contains the PRx 175.

Referring to the third example 180, a foreign object 190 (sometimes referred to as a foreign metal object) may be in the operative environment of the primary coil 130. An FO 190 may be any object that is electrically conductive or has magnetic permeability and that is not intended as an induction heating device 165 or a PRx 175. When an FO 190 is in the operative environment of the primary coil 130 and the primary coil 130 is generating a magnetic field, the FO 190 may be undesirably heated. There exists a potential of fire, damage to the PTx 120, or harm to a user if the FO 190 is heated by either induction heating or wireless power transfer. Therefore, when an FO 190 is detected, the PTx 120 may discontinue generating the primary magnetic field or otherwise prevent the PTx 120 from transferring sufficient amounts of energy in the FO 190 to cause the FO 190 to heat beyond a safe level.

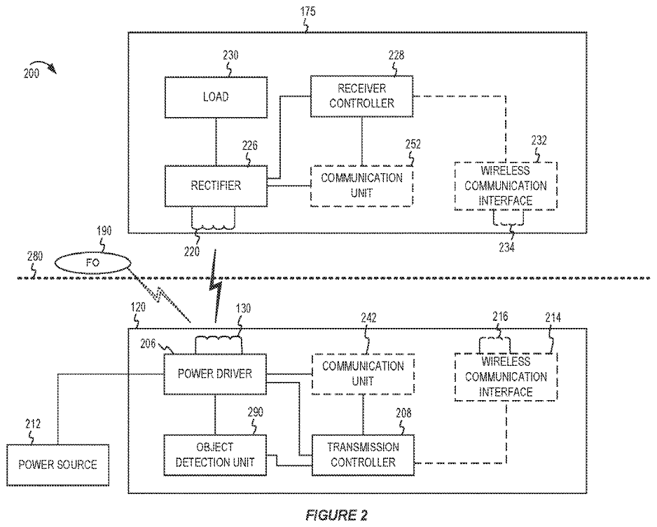

FIG. 2 shows a block diagram of an example wireless power transfer system 200. The wireless power transfer system may include the PTx 120 and the PRx 175 as described with reference to FIG. 1. The PTx 120 may include one or more primary coils 130 configured to transmit wireless energy (as a wireless power signal) to one or more corresponding secondary coils 220 in the PRx 175. A primary coil refers to a source of wireless energy (such as inductive or magnetic resonant energy producing an electromagnetic field) in the Power Transmitter. The primary coil 130 may be associated with a power driver 206. The primary coil 130 may be a wire coil which transmits wireless power (which also may be referred to as wireless energy or a wireless power signal). Together, the power driver and the primary coil may generate a primary magnetic field during wireless power transfer. The power driver 206 may include components (not shown) to provide power to the primary coil 130 causing the primary coil 130 to produce the wireless power signal. For example, the power driver 206 may include one or more switches, drivers, series capacitors, rectifiers or other components. The PTx 120 also may include a transmission controller 208 (sometimes also referred to as a PTX controller, or controller for brevity) that controls the components of the power driver 206. For example, the transmission controller 208 may determine an operating point (such as voltage or current) and control the power driver 206 according to the operating point.

In some implementations, the power driver 206, the transmission controller 208 and other components (not shown) may be collectively referred to as a power transmitter circuit. Some or all of the power transmitter circuit may be embodied as an integrated circuit (IC) that implements features of this disclosure for controlling and transmitting wireless power to one or more Power Receivers. The transmission controller 208 may be implemented as a microcontroller, dedicated processor, integrated circuit, application specific integrated circuit (ASIC) or any other suitable electronic device.

A power source 212 may provide power to the power transmitter circuit in the PTx 120. The power source 212 may convert alternating current (AC) power to direct current (DC) power. For example, the power source 212 may include a converter that receives an AC power from an external power supply (such as a supply mains) and converts the AC power to a DC power used by the power driver 206.

In some implementations, a first communication unit 242 may be coupled to the components of the power driver 206 or the primary coil 130 to send or receive communications via the wireless power signal. The first communication unit 242 may include logic for controlling one or more switches and other components that cause transmission and reception of wireless signals via the wireless power signal. For example, the first communication unit 242 may include modulators or demodulators that convert information to modulated signals added to the wireless power signal. In one example, the first communication unit 242 may convert data from the transmission controller 208 into a frequency shift key (FSK) modulated signal that is combined with the wireless power signal for a communication from the PTx 120 to the PRx 175. In another example, the first communication unit 242 may sense load modulated amplitude shift key (ASK) signals from the power driver 206 or the primary coil 130 and demodulate the ASK signals to obtain data that the first communication unit 242 provides to the transmission controller 208.

In some implementations, the PTx 120 may include a wireless communication interface 214. The wireless communication interface 214 may be connected to a first communication coil 216 (which may be a coil or a loop antenna). The wireless communication interface 214 may include logic for controlling one or more switches and other components that cause transmission and reception of wireless communication signals via the first communication coil 216. In some implementations, the wireless communication interface 214 may support short range radio frequency communication (such as Bluetooth™) or Near-Field Communication (NFC). NFC is a technology by which data transfer occurs on a carrier frequency of 13.56 MHz. The wireless communication unit 214 also may support any suitable communication protocol.

The transmission controller 208 may detect the presence or proximity of a PRx 175 using a variety of techniques. In some implementations, the presence or proximity of the PRx 175 may be detected based on a load change in response to a periodic low power signal generated by the power driver 206 and the primary coil 130. In some implementations, the presence or proximity of the PRx 175 may happen during a periodic pinging process of the wireless communication interface 214 in the PTx 120. When a PRx 175 is placed on the interface surface of the PTx 120, a pinging of the wireless communication interface 214 via the first communication coil 216 may be responded by a reply communication from the PRx 175. The pinging and reply communication may form part of a handshaking process that includes two-way communication between the PTx 120 and the PRx 175. Based on the successful handshaking, the transmission controller 208 may determine that a PRx 175 is detected. As described herein, the PTx 120 can perform an object detection assessment that can detect the presence of an induction heating device (not shown), the PRx 175, or the FO 190. The PTx 120 might perform the object detection assessment at various times which might be before and/or after the periodic low power signal or the periodic pinging process of a traditional wireless power system.

The transmission controller 208 may control characteristics of wireless power that the PTx 120 provides to the PRx 175. After detecting the PRx 175, the transmission controller 208 may receive information from a PRx 175. For example, the transmission controller 208 may receive the information during a hand shaking process with the PRx 175. The information may include information about the PRx 175 (such as a power rating, load states, the manufacturer, the model, or parameters of the receiver when operating on a standard transmitter, among other examples). The transmission controller 208 may use this information to determine at least one operating control parameter (such as frequency, duty cycle, voltage, etc.) for wireless power it provides to the PRx 175. To configure the wireless power, the transmission controller 208 may modify the frequency, duty cycle, voltage or any other suitable characteristic of the power driver 206.

The PRx 175 may include a secondary coil 220, a rectifier 226, and a receiver controller 228. The secondary coil 220 may receive the wireless energy via the electromagnetic field. When the secondary coil 220 is aligned to the primary coil 130, the secondary coil 220 may generate an induced voltage based on a received wireless power signal from the primary coil 130. A capacitor (not shown) and a switch (not shown) may be in series between the secondary coil 220 and the rectifier 226. The rectifier 226 may rectify the induced voltage and provide the induced voltage to a load 230. In some implementations, the load 230 may be external to the PRx 175 and coupled via electrical lines from the rectifier 226. In some implementations, the rectifier 226 may be absent and the induced voltage in the secondary coil 220 may be fed to the elements in series to the secondary coil 220 and the load 230.

A receiver controller 228 may be connected to the rectifier 226 and a second communication unit 252. The second communication unit 252 may be coupled to the components of the secondary coil 220 or the rectifier 226 to send or receive communications via the wireless power signal. The second communication unit 252 may include logic for controlling one or more switches and other components that cause transmission and reception of communication signals via the wireless power signals. For example, the second communication unit 252 may include modulators or demodulators that convert information to ASK or FSK modulated signals. In one example, the second communication unit 252 may convert data from the receiver controller 228 into an ASK modulated signal that is used to load modulate the wireless power signal for a communication from the PRx 175 to the PTx 120. In another example, the second communication unit 252 may sense FSK signals in the wireless power signal at the secondary coil 220 or the rectifier 226 and demodulate the FSK signals to obtain data that the second communication unit 252 provides to the receiver controller 228.

In some implementations, the PRx 175 may include a wireless communication interface 232. The wireless communication interface 232 may contain modulation and demodulation circuits to wirelessly communicate via a second communication coil 234 (which may be a coil or a loop antenna). Thus, the receiver controller 228 may wirelessly communicate with the transmission controller 208 via the wireless communication interface 232 and the wireless communication interface 214 using NFC communications or Bluetooth.

An interface surface 280 (sometimes also referred to as an “interface space”) may demark a space between the Power Transmitter and the Power Receiver. For example, the interface surface may include a surface of the Power Transmitter on which the Power Receiver may be placed. A distance between the primary coil 130 and the secondary coil 220 may include a thickness of a surface in the interface surface. During wireless power transfer, the primary coil 130 may induce a magnetic field (referred to as the primary magnetic field) through the interface surface and into an operative environment in which the secondary coil is placed. Thus, the “operative environment” is defined by the primary magnetic field in the system, where the primary magnetic field of a primary coil 130 is detectably present and can detectably interact with the secondary coil or a foreign object 190 (shown as FO 190).

When a foreign object 190 is present in the operative environment of the WPT system, the foreign object 190 may experience an increase in temperature due to interaction with the magnetic field. Therefore, when a foreign object is detected, the PTx 120 discontinues generating the primary magnetic field or otherwise prevents the PTx 120 from transferring amounts of energy in the foreign object 190 that would cause the foreign object 190 to heat beyond a safe level.

The PTx 120 also may include an object detection unit 290. In some implementations, the object detection unit 290 might be referred to as a pot/pan detection unit, a PRx detection unit, or an FO detection unit. In some implementations, the object detection unit 290 may be integrated in the transmission controller 208. For example, the object detection unit 290 may be collocated or implemented as software within the transmission controller 208. Alternatively, or additionally, the object detection unit 290 may be implemented as a separate system of the PTx 120 or a multi-function hob that includes the PTx 120. For example, the multi-function hob may include an object detection mat configured to detect an induction heating device, a PRx, or a foreign object at any one of multiple PTx locations.

The object detection unit 290 may be configured to detect an object in the operative environment of the PTx 120 based on a measurement value obtained in conjunction with an object detection pulse. The object detection pulse might be generated by the power driver 206 or a different driver (not shown. The object detection unit 290 might cause the object detection pulse to be transmitted via the primary coil 120 or one or more object detection coils (not shown) as part of an object detection assessment. The object detection unit 290 might obtain the measurement value while the pulse is transmitted. The object detection unit 290 may provide the measurement value to the transmission controller 208 so that the transmission controller 208 can compare the measurement value with one or more thresholds to detect various types of objects. Alternatively, the object detection unit 290 might perform the comparison of the measurement value with the one or more thresholds and provide a result of the object detection assessment to the transmission controller 208.

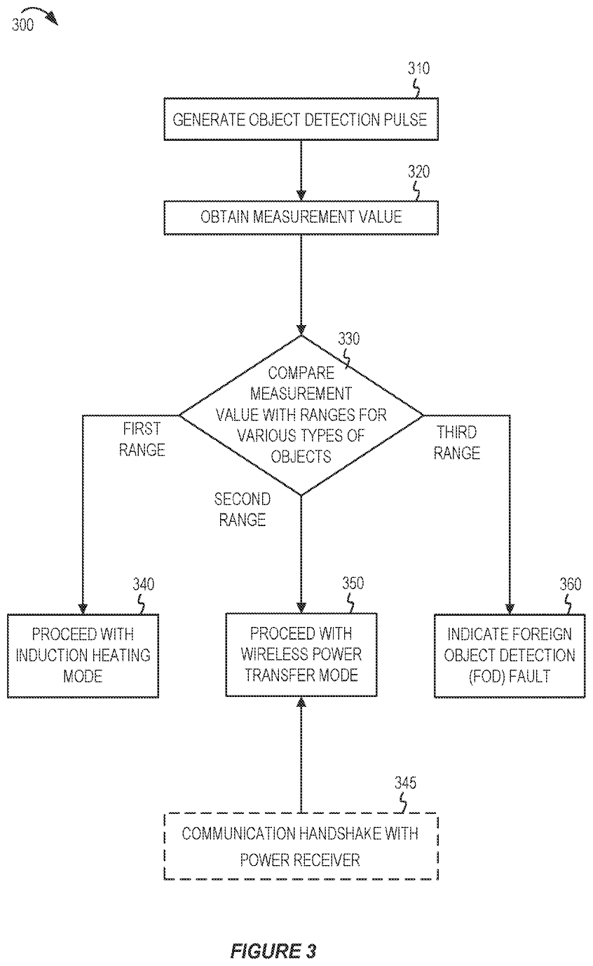

FIG. 3 shows a flowchart diagram of an example process 300 for an object detection assessment. The operations of the process 300 might be implemented by a controller or an object detection unit of a PTx, such as the transmission controller 208 or the object detection unit 290 described with reference to FIG. 2. In some implementations, the process 300 might be implemented by a controller that is included in, or part of, a processor of a multifunction hob.

In some implementations, the steps of process 300 may begin after the PTx has detected or received an indication that a PRx or induction heating device is present near the PTx. For example, the PTx might receive a wireless communication or read an NFC tag, either of which might indicate the presence of a PRx or induction heating device. Alternatively, the controller might periodically perform the process 300 to detect an object and determine the type of object. In such a scenario, not all steps of 300 may be implemented.

At block 310, the controller causes a power driver or other component to generate an object detection pulse. The object detection pulse might be a lower power signal transmitted by a primary coil or one or more detection coils.

At block 320, the controller obtains a measurement value associated with the object detection pulse. For example, the controller might obtain the measurement value from a voltage sensor, current sensor, impedance sensor, or other measurement unit connected to the primary coil or one or more detection coils. In some implementations, the measurement value might be a measured parameter (such as coil impedance, coil current, or coil voltage) of the primary coil or at the output of the power driver. Alternatively, the measurement value might be the difference between the measurement parameter at two or more detection coils, such that the measurement value represents a differential impedance, differential current, or differential voltage. In the example of FIG. 3, the measurement value is indicative that an object is present in the magnetic field of the PTx. For example, the object might be detected based on the measurement value being different from a steady state measurement value in which no objects are present.

At block 330, the controller compares the measurement value with threshold ranges. In some implementations, one or more of the threshold ranges may be predefined or preconfigured in a memory of the controller. In the example of FIG. 3, a first range represents the range of measurement values expected for an induction heating device, a second range represents the range of measurement values expected for a PRx, and a third range represents the range of measurement values expected for a foreign object. If the measurement value is within the first range, the flowchart continues to block 340. If the measurement value is within the second range, the flowchart continues to block 350. If the measurement value is within the third range, the flowchart continues to block 360. If the measurement value is not within any of the first, second, or third ranges, the controller might default to block 360 or might restart the object detection assessment.

At block 340, when the measurement value was within the first range, the controller may determine that the object is an induction heating device, such as a pot or a pan. The controller may proceed with an induction heating mode of operation.

At block 350, when the measurement value was within the second range, the controller may determine that the object is an appliance that includes a PRx. The controller may proceed with a wireless power transfer mode of operation.

At block 360, when the measurement value was within the third range, the controller may determine that the object is a foreign object. The controller may indicate a foreign object detection (FOD) fault, such as via a user interface associated with the PTx.

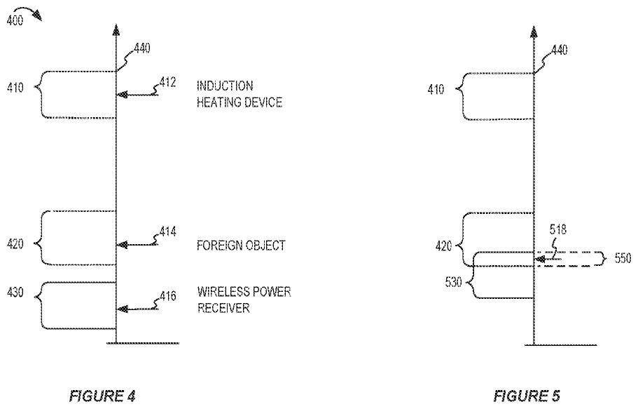

The operations described with reference to FIG. 3 enable a PTx to detect various types of objects using an object detection pulse. As described further with reference to FIGS. 4 and 5, the various ranges of measurement values may cause unpredictable or inaccurate results absent the techniques of this disclosure.

In some implementations, the PTx might perform blocks 310, 320, 330, 340, and 360 as part of a pot detection assessment. The PTx might detect the presence of a PRx using an alternative technique, such as a communication from the PRx. For example, at block 345, the PTx might detect the PRx using a communication handshake that includes pinging using an NFC coil and a response from the PRx. In this scenario, when the communication handshake is achieved, the PTx might skip the pot detection assessment and proceed directly to block 350 to proceed with wireless power transfer mode. In the wireless power transfer mode, the PTx can use an object detection assessment (this time referred to as a foreign object detection assessment) to determine whether a foreign object is present with the PRx. The foreign object detection assessment includes an object detection pulse (similar to block 310), obtaining a measurement value (similar to block 320), and a comparison of the measurement value to the second range and/or the third range (similar to block 330). In some implementations, the measurement value in a foreign object detection assessment might be based on a coupling factor measurement. The foreign object detection assessment typically happens in a connected phase of power transfer protocol executed by the PTx and PRx during which the secondary coil of the PRx is disconnected using a series switch from the rest of the PRx circuit and load.

FIG. 4 is a diagram 400 conceptually illustrating various ranges and measurement values for object detection. A scale 440 may represent the various measurement values that might be obtained during an object detection assessment. A first range 410 might be associated with induction heating devices. A second range 420 might be associated with foreign objects, and can be referred to as an FO threshold range. A third range 430 might be associated with a wireless power receiver, and can be referred to as a PRx threshold range. Depending on where the measurement value is in the scale 440, the measurement value might be within the first range 410, the second range 420, or the third range. For example, a first measurement value 412, obtained when an induction heating device is present, is within the first range 410. A second measurement value 414 obtained when a foreign object is present, is within the second range 420. A third measurement value 416 obtained when a wireless power receiver (or appliance containing a PRx) is present, is within the third range 430.

As described herein, there may be instances in which a PRx (or an appliance containing the PRx) has friendly metals. The friendly metals might shift the range of expected measurement values closer to, or overlapping with, the second range 420 associated with foreign objects.

FIG. 5 is a diagram 500 conceptually illustrating a measurement value and range for a PRx with friendly metals. In FIG. 5, the first range 410 and second range 420 are shown on the scale 440, as described with reference to FIG. 4. However, a third range 530 shows the range of measurement values that might be expected for a PRx having friendly metals. As shown in FIG. 5, there might be an overlapping range of values 550 that fall within the second range 420 and the third range 530. Furthermore, a measurement value 518 might be for a foreign object or a PRx. Using the techniques of this disclosure, a PTx (or controller) can determine whether the measurement value 518 is a PRx with friendly metals or a foreign object.

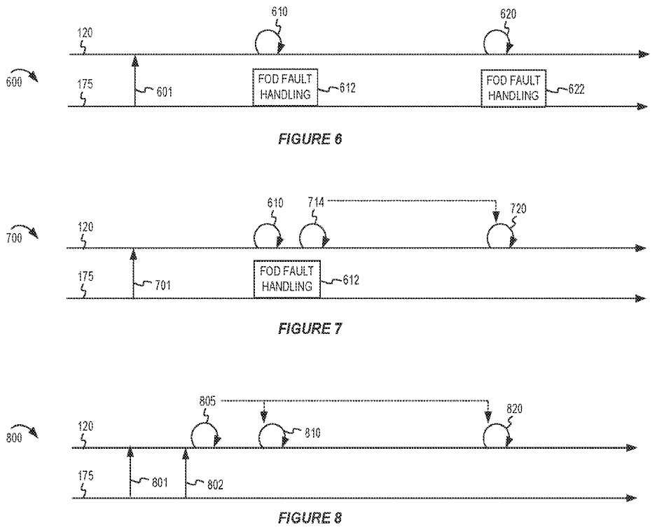

FIG. 6 is a timing diagram 600 showing a baseline scenario when a PRx with friendly metals is repeatedly detected as a foreign object. As mentioned earlier, the object detection pulse may also be used for FOD in the presence of a valid PRx identified using a communication handshake. The timing diagram 600 shows a communication 601 from the PRx to the PTx as part of the communication handshake. The timing diagram 600 shows a PTx 120 performing a first object detection assessment 610 (which may be referred to as a foreign object detection assessment) in which a PRx 175 is present. The first object detection assessment 610 might occur before the PTx 120 proceeds with a wireless power transfer mode. Alternatively, or additionally, the first object detection assessment 610 might occur in the connected phase before the PTx 120 transitions to a power transfer phase.

In the example of FIG. 6, the PRx 175 has friendly metals which might cause the PRx 175 to be incorrectly detected as a foreign object. For example, the measurement value for the first object detection assessment 610 might be within the overlapping range of values 550 described with reference to FIG. 5. Because the measurement value is within the overlapping range of values, the first object detection assessment 610 might result in an FOD fault. A first FOD fault handling 612 might include a user interaction, such as removing the PRx 175 from the interface surface and placing it again on the PTx 120. Alternatively, or additionally, the first FOD fault handling 612 might include a user interface, button, or other action. The user interaction might be designed to inform the PTx 120 that the object that it has detected in the first object detection assessment 610 is actually the PRx 175 rather than a foreign object. After the first FOD fault handling 612, the PTx 120 may proceed with other operations such as transferring power in the wireless power transfer mode of operation.

Later, the PRx 175 might request the PTx 120 to transition to a connected mode and stay in that phase until the next power transfer phase. In some cases, the PRx 175 might periodically request transitions to the power transfer phase or the connected phase-resulting in multiple subsequent object detection assessments for detecting the presence of FO. For brevity, FIG. 6 shows only one subsequent object detection assessment (the second object detection assessment 620). In the baseline scenario, the second object detection assessment 620 results in another FOD fault, requiring a second FOD fault handling 622. The second FOD fault handling 622 also might include a user interaction. Because of the repetitive FOD faults, the operator of the PRx 175 might be required to perform multiple user interactions, causing frustration or dissatisfaction.

FIG. 7 is a timing diagram 700 showing an example scenario in which a reference value for a PRx with friendly metals can be used for a subsequent object detection assessment. As with FIG. 6, the timing diagram 700 shows a communication 701 from the PRx to the PTx as part of a communication handshake. The timing diagram 700 also shows a PTx 120 performing a first (Foreign) object detection assessment 610 in which a PRx 175 is present. However, FIG. 7 differs from FIG. 6 in that, following the first FOD fault handling 612, the PTx 120 might store a reference value (shown at block 714) for the PRx 175. For example, the reference value might be the measurement value of the first object detection assessment 610. In some implementations, the reference value might be stored in association with an identification (ID) of the PRx 175, such as an ID in a communication (not shown) from the PRx 175 to the PTx 120.

Proceeding with FIG. 7, the PTx 120 might perform a subsequent object detection assessment (the second foreign object detection assessment 720). The PTx 120 might compare the measurement value of the second object detection assessment 720 with the reference value 714. If the measurement of the second object detection assessment 720 is within a threshold range of the reference value 714, the PTx 120 might determine that the detected object is the PRx 175 previously detected.

In some implementations, when the PRx 175 moves in the operative environment of the PTx 120, the measurement value might change. Similarly, the measurement value might change as a result of temperature drift or other discernable changes in which the measurement value is impacted without the introduction of a foreign object. The PTx 120 might determine that the change in measurement value is due to the movement, temperature drift, or other discernable changes related to the PRx 175 rather than introduction of a foreign object. For example, a change in alignment of receiver can be determined based on a change in the measurement values from the Power Receiver for the foreign object detection pulse applied at the Power Transmitter. When the PTx 120 determines that the measurement value has changed and no FO has been introduced, the PTx 120 might store the changed measurement value as an updated reference value for the PRx 175 and use the updated measurement value for subsequent object detection assessments (not shown).

FIG. 8 is a timing diagram 800 showing an example scenario in which a communication from a PRx with friendly metals can improve object detection assessment results. As with FIGS. 6 and 7, the timing diagram 800 shows operations related to a PTx 120 and a PRx 175. The PTx 120 detects the PRx 175 by a communication 801 from the PRx to the PTx as part of a communication handshake. FIG. 8 differs from FIGS. 6 and 7 in that the PRx 175 is configured to communicate a communication 802 to the PTx 120. The communications 801 and 802 might be short-range radio frequency communications (such as using NFC). The communications 801 and 802 might be active transmissions or passive transmissions. A passive transmission might include an NFC tag integrated or attached to the PRx 175 and readable by an NFC interface of the PTx 120. The communication 802 might be an NFC data exchange format (NDEF) message. The communication 802 might include a reference measurement value, a range of expected measurement values, or a friendly metals indication.

In one example, the communication 802 includes a reference measurement value obtained by a standard Power Transmitter performing a test object detection assessment in which the PRx 175 is present without a foreign object. At block 805, the PTx 120 might store the reference measurement value as a reference value for the PRx 175. During each of object detection assessments 810 and 820, the PTx 120 might determine that a detected object is the PRx 175 without a FO when the measurement values are within a PRx threshold range of the reference value (stored in block 805). Thus, the PTx 120 might refrain from triggering an FOD fault and prevent the need for FOD fault handling.

In another example, the communication 802 includes a range of expected measurement values for the PRx 175. For example, the range of expected measurement values might indicate a threshold of acceptable measurement values of an object detection assessment that should result in the detection of the PRx 175 rather than a foreign object. At block 805, the PTx 120 might store the range of expected measurement values and determine the PRx threshold range based on the range of expected measurement values. During each of object detection assessments 810 and 820, the PTx 120 might determine that a detected object is the PRx 175 when the measurement values are within the range of expected measurement values (stored in block 805). Alternatively, at block 805, the PTx 120 might calculate a reference value based on the range of expected measurement values and store the reference value.

The range can be any variety of formatting, including an offset value, a minimum value, maximum value, minimum and maximum value, or a scaler coefficient, among other examples. Referring to FIGS. 3-5, the range of expected measurement values might be the third range 430 or 530. If the range of expected measurement values overlaps the second range 420, the PTx 120 might override the second range 420 for the overlapping range 550 and treat any measurement values in the overlapping range 500 as being within the third range 530 (the range of expected measurements value) and detect the object as a PRx rather than a foreign object.

In yet another example, the communication 802 includes a friendly metals indication. For example, the friendly metals indication might be a value or bit that informs the PTx 120 that the PRx 175 has friendly metals. The PTx 120 might store the friendly metals indication at block 805. During each of object detection assessments 810 and 820, the PTx 120 might determine that a detected object is the PRx 175 when the friendly metals indication has been received in a communication 802 from the PRx 175. For example, the PTx 120 might override a measurement value that would otherwise be associated with a foreign object.

In another example method, when a PRx 175 is placed on a PTx 120 for a first time, the PRx may indicate the presence of friendly metals 802. The PTx stores the information 805. During the very first object assessment (object detection assessment 810), the PTx 120 stores the measurement value along with the PRx ID in its non-volatile memory. During subsequent object detection assessment (such as object detection assessment 820) either during the first time placement or during subsequent placements of PRx 175 over PTx 120, the PTx 120 checks if the measurement value is within a PRx threshold range of the stored measurement value corresponding to that PRx 175. If the measurement value is outside the PRx threshold range, the PTx 120 triggers a FOD action. The FOD action might prompt a user action to confirm that no FO is present. If the user action confirms that no FO is present, the PTx 120 updates the stored measurement value corresponding to the PRx 175 in its non-volatile memory. The value can be either replaced or the range of values can be updated.

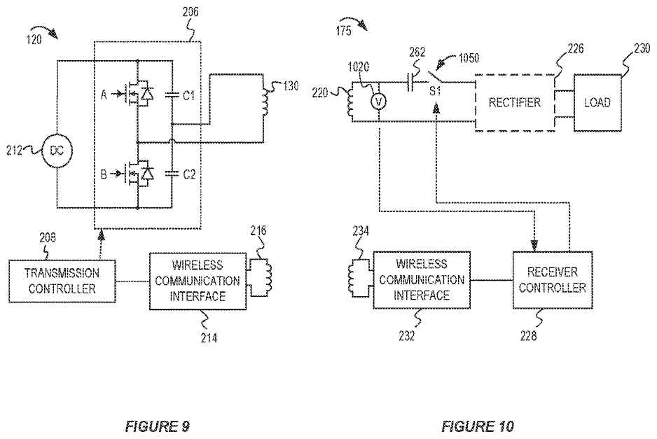

FIG. 9 shows a block diagram of an example PTx 120. The PTx 120 may include a power source 212, a power driver 206, a transmission controller 208, a primary coil 130, a wireless communication interface 214 and a first communication coil 216 as described with reference to FIG. 2. The power driver 206 is illustrated with a half-bridge circuit to convert a DC power from the power source 212 to an AC signal applied to the primary coil 130. Although not illustrated in FIG. 8, the power source 212 may include a conversion unit that converts an AC mains power to the DC power of the power source 212. Furthermore, the power driver 206 may be any type of power conversion circuit capable of providing an AC signal to the primary coil 130. For example, the power driver 206 may include the half-bridge circuit with parallel capacitors as shown in FIG. 8. Alternatively, the power driver 206 may include a full-bridge circuit.

The transmission controller 208 may cause the PTx 120 may transmit an object detection pulse via the primary coil 130. The object detection pulse also may be referred to as a ping or a “pan detect” signal in some implementations. When an induction heating device is placed near the primary coil 130, the PTx 120 (or an object detection unit therein) may measure a change in a measurement value (such as the impedance) to detect whether the induction heating device is located over the primary coil 130. If the measurement value falls within a predetermined range (such as a tolerance limit), then the PTx 120 changes operation from ping mode to induction-based heating mode in which it transfers energy using induction. Hence, the induction heating device might be detected based on impedance offered by the pan/appliance. In the case of a Power Receiver (such as those described herein), the one or more switches may cause the impedance of the secondary coil to be outside the tolerance limit. For example, a series switch may cause the impedance measured by the PTx 120 to be higher than the tolerance limit.

In some implementations once a Power Receiver is detected (such as by a communication handshake), the object detection pulse may be used concurrently to detect the presence of FO with Power Receiver as well as to determine a coupling factor of the Power Receiver. A coupling factor (sometimes referred to as a k-factor) may be an indication of how well a secondary coil and a primary coil are capable of transferring wireless power. For example, the k-factor may be a measure of a potential flux linkage of wireless power transfer between the primary coil and the secondary coil. In some implementations, the k-factor may depend on, among other things, the quantity of turns (n1) in a primary coil, the quantity of turns (n2) in a secondary coil, a voltage (v1) transmitted by the primary coil, and a voltage (v2) induced in the secondary coil during a measurement period. The voltage v1 also may be referred to as a transmitted voltage, and the voltage v2 also may be referred to as a received voltage. The k-factor may be calculated as follows (equation 1):

$$kfactor = \frac{v 2}{v 1} * \frac{n 1}{n 2} \qquad ( 1 )$$

In some implementations, it is desirable to disconnect the secondary coil from other components of the Power Receiver during a measurement period for determining the k-factor. Thus, in some implementations, a Power Receiver may use one or more switches to disconnect a secondary coil from one or more other components (such as a rectifier, a load, or both) during an object detection assessment when the object detection assessment is combined with a k-factor measurement.

FIG. 10 shows a block diagram of an example PRx 175 with a switch to enable disconnection of a secondary coil during an object detection assessment with coupling factor measurement. The components of the PRx 175 may include components having like numbers as the PRx 175 described with reference FIG. 2. FIG. 10 shows a switch 1050 as a series switch on one leg of the secondary coil 220. However, in some implementations, the switch 1050 may be any type of switch that prevents or minimizes a current from passing through the secondary coil 220 when the switch 1050 is in the first position. In FIG. 10, the first position of the switch 1050 is an open position so that the circuit that includes the secondary coil 220 does not conduct a current. The PRx 175 also may include a voltage sensor 1020 coupled to the secondary coil 220. During an object detection assessment, the receiver controller 228 may cause the switch 1050 to disconnect the secondary coil 220 from the power reception circuit (such as the rectifier 226 and the load 230). During a power transfer phase, the receiver controller 228 may cause the switch 1050 to connect the secondary coil 220 to the power reception circuit.

The switch 1050 also may be used to disconnect the secondary coil 220 from the power reception circuit (such as the rectifier 226, the load 230, or both) when an object detection assessment is performed. The object detection assessment may include any of the operations described herein, such as the object detection assessment described with reference to FIGS. 3-8. The object detection assessment might be performed during a foreign object detection (FOD) period, a k-factor measurement period, or both.

In FIG. 10, the object detection assessment (performed as a foreign object detection assessment) is combined with a coupling factor measurement. As part of the foreign object detection assessment with a valid PRx receiver during the connected phase, the PTx (not shown) may transmit an object detection pulse. In some implementations, the object detection pulse may be transmitted using a known or predetermined voltage (v1) and frequency (fp). The PTx may determine the presence of FO based on the measurement value (voltage or current or impedance or quality factor) used for detecting FO. Concurrently, the voltage sensor 1020 may permit the receiver controller 228 to measure a received voltage (v2) of the secondary coil 220 induced by the object detection pulse. The receiver controller 228 may communicate a message to the PTx via the wireless communication interface 232. The message may include a received voltage value based on the measured v2. The PTx may utilize the received voltage value to determine a coupling factor (k-factor). The k-factor may be used by the PTx to determine the operating point of a wireless power signal that the PTx transmits during the power transfer phase. For example, the operating point may be based on a calculation that accounts for the ratio between the v1 and the v2. Thus, the same object detection pulse is used for measurement of coupling factor as well as detecting the presence of FO.

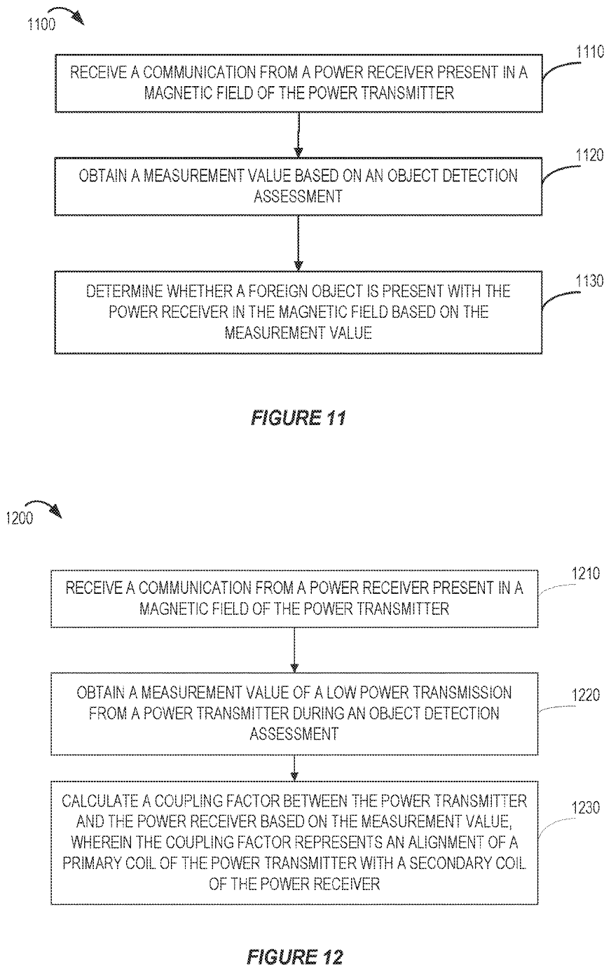

FIG. 11 shows a flowchart diagram of an example process 1100 according to some aspects of this disclosure. In some implementations, one or more process blocks of FIG. 11 may be performed by a PTx, such as the PTx 120 described herein. Alternatively, one or more process blocks of FIG. 11 may be performed by a controller or an object detection unit of a PTx. For brevity, the process blocks are described as performed by a PTx.

At block 1110, the PTx receives a communication from a Power Receiver present in a magnetic field of the Power Transmitter. The communication might be part of a communication handshake that is indicative of the Power Receiver being present. At block 1120, the PTx obtains a measurement value based on an object detection assessment. At block 1130, the PTx determines whether a foreign object is present with the Power Receiver in the magnetic field based on the measurement value. For example, the PTx might determine that the foreign object is not present when the measurement value is outside a foreign object (FO) threshold range for foreign objects. Alternatively, or additionally, the PTx might determine that the foreign object is not present when the measurement value is within a Power Receiver (PRx) threshold range based on a reference measurement value for the PRx. In some implementations, the FO threshold range may be similar to the third range described with reference to FIGS. 3-4. In some implementations, the PRx threshold range may be similar to the second range described with reference to FIGS. 3-4. In some implementations, the PRx threshold range might be based on a previous object detection assessment or a communication from the Power Receiver as described with reference to FIGS. 7-8.

Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 shows a flowchart diagram of an example process 1200 according to some aspects of this disclosure. In some implementations, one or more process blocks of FIG. 12 may be performed by a PTx, such as the PTx 120 described herein. Alternatively, one or more process blocks of FIG. 12 may be performed by a controller or an object detection unit of a PTx. For brevity, the process blocks are described as performed by a PTx.

At block 1210, the PTx receives a communication from a Power Receiver present in a magnetic field of the Power Transmitter. At block 1220, the PTx obtains a measurement value of a low power transmission from the PTx during an object detection assessment. At block 1230, the PTx calculates a coupling factor between the PTx and the PRx based on the measurement value, where the coupling factor represents an alignment of a primary coil of the PTx with a secondary coil of the PRx.

Although FIG. 12 shows example blocks of process 1200, in some implementations, process 1200 may include additional blocks, fewer blocks, different blocks, or differently arranged blocks than those depicted in FIG. 12. Additionally, or alternatively, two or more of the blocks of process 1200 may be performed in parallel.

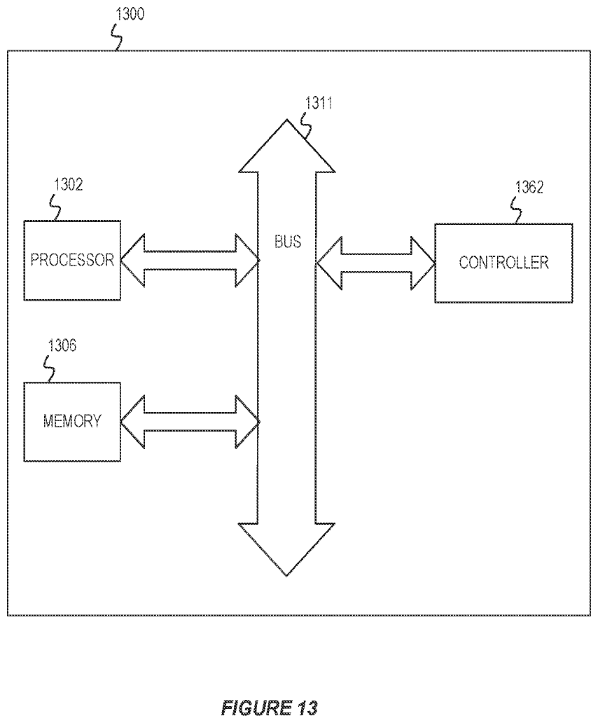

FIG. 13 shows a block diagram of an example apparatus 1300 for use in a multi-function hob. In some implementations, the apparatus 1300 may be part of a PTx, such as any of the PTx's described herein. In some implementations, the apparatus 1300 may be implemented as part of a multi-function hob that includes one or more PTx capable of operating in an induction heating mode and a wireless power transfer mode. The apparatus 1300 can include a processor 1302 (possibly including multiple processors, multiple cores, multiple nodes, or implementing multi-threading, etc.). The apparatus 1300 also can include a memory 1306. The memory 1306 may be system memory or any one or more of the possible realizations of computer-readable media described herein. The apparatus 1300 also can include a bus 1311 (such as PCI, ISA, PCI-Express, HyperTransport®, InfiniBand®, NuBus®, AHB, AXI, etc.).

The apparatus 1300 may include one or more controllers (such as controller 1362) configured to manage an object detection assessment. The object detection assessment may be performed by an object detection unit (not shown). Alternatively, the controller 1362 might implement the object detection unit. In some implementations, the controller 1362 can be distributed within the processor 1302, the memory 1306, and the bus 1311. The controller 1362 may perform some or all of the operations described herein.

The memory 1306 can include computer instructions executable by the processor 1302 to implement the functionality of the implementations described with reference to FIGS. 1-12. Any one of these functionalities may be partially (or entirely) implemented in hardware or on the processor 1302. For example, the functionality may be implemented with an application specific integrated circuit, in logic implemented in the processor 1302, in a co-processor on a peripheral device or card, etc. Further, realizations may include fewer or additional components not illustrated in FIG. 13. The processor 1302, the memory 1306, and the controller 1362 may be coupled to the bus 1311. Although illustrated as being coupled to the bus 1311, the memory 1306 may be coupled to the processor 1302.

The figures, operations, and components described herein are examples meant to aid in understanding example implementations and should not be used to limit the potential implementations or limit the scope of the claims. Some implementations may perform additional operations, fewer operations, operations in parallel or in a different order, and some operations differently.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (enumerated as clauses for clarity).

### CLAUSES

Clause 1. A method for wireless power transfer by a Power Transmitter, including: receiving a communication from a Power Receiver present in a magnetic field of the Power Transmitter; obtaining a measurement value based on an object detection assessment; and determining whether a foreign object is present with the Power Receiver in the magnetic field based on the measurement value.

Clause 2. The method of clause 1, where determining whether the foreign object is present includes at least one of: determining that the foreign object is not present when the measurement value is outside a foreign object (FO) threshold range for foreign objects, or determining that the foreign object is not present when the measurement value is within a Power Receiver (PRx) threshold range based on a reference measurement value for the PRx.

Clause 3. The method of clause 2, where determining whether the foreign object is present further includes at least one of: determining that the foreign object is present when the measurement value is outside the PRx threshold range, or determining that the foreign object is present when the measurement value is within the FO threshold range.

Clause 4. The method of any one of clauses 2-3, where the PRx threshold range and the FO threshold range overlap each other, and where the measurement value is compared with the PRx threshold range before the measurement value is compared with the FO threshold range.

Clause 5. The method of any one of clauses 2-4, further including: determining the PRx threshold range based on a fixed offset of a reference value for the Power Receiver.

Clause 6. The method of any one of clauses 2-5, further including: determining the PRx threshold range based on a previous measurement value of a previous object detection assessment in which the Power Transmitter confirmed that the foreign object is not present with the Power Receiver in the magnetic field.

Clause 7. The method of clause 6, further including: detecting a user action after the previous object detection assessment when the previous object detection assessment is in the FO threshold range, where the user action is indicative that no foreign object is present in the magnetic field; storing the previous measurement value as a reference value for the Power Receiver; and updating the PRx threshold range based on the reference value.

Clause 8. The method of clause 6, further including: receiving a communication from the Power Receiver after the previous object detection assessment when the previous object detection assessment is in the FO threshold range, where the communication is indicative that no foreign object is present in the magnetic field; storing the previous measurement value as the reference value for the Power Receiver; and updating the PRx threshold range based on the reference value.

Clause 9. The method of any one of clauses 2-8, further including: receiving a communication from the Power Receiver, the communication indicating the PRx threshold range for the Power Receiver, the PRx threshold range having been measured in a test environment when the Power Receiver was placed on a standard Power Transmitter with no foreign object present.

Clause 10. The method of any one of clauses 2-9, further including: receiving a communication from the Power Receiver, the communication indicating a reference value for the Power Receiver; and determining the PRx threshold range based on the reference value.

Clause 11. The method of clause 10, where the reference value includes a reference measurement value having been measured in a test environment when the Power Receiver was placed on a standard Power Transmitter.

Clause 12. The method of any one of clauses-2-11, further including: receiving a communication from the Power Receiver, the communication indicating that the Power Receiver contains friendly metals; and determining the PRx threshold range based on a predetermined measurement value for Power Receivers that contain friendly metals.

Clause 13. The method of any one of clauses 2-12, further including: receiving a communication from the Power Receiver, the communication indicating a range of expected measurement values for the Power Receiver; and determining the PRx threshold range based on the range of expected measurement values.

Clause 14. The method of any one of clauses 2-13, further including: obtaining the PRx threshold range, or a reference value indicative of the PRx threshold range, or both, from a data field in an out-of-band communication received by the Power Transmitter from the Power Receiver.

Clause 15. The method of clause 14, where the out-of-band communication is a near field communication (NFC) data exchange format (NDEF) message.

Clause 16. The method of any one of clauses 1-11, further including: enabling a wireless power transfer mode of the Power Transmitter if the foreign object is not present with the Power Receiver; and disabling the wireless power transfer mode of the Power Transmitter if the foreign object is present with the Power Receiver.

Clause 17. The method of any one of clauses 2-16, further including: calculating a coupling factor between the Power Transmitter and the Power Receiver based on the measurement value, where the coupling factor represents an alignment of a primary coil of the Power Transmitter with a secondary coil of the Power Receiver.

Clause 18. The method of any one of clauses 1-17, where the measurement value is at least one value selected from a group consisting of: a coil voltage or a differential voltage of two or more detection coils of a coil pair; a coil current or a differential current of the two or more detection coils of the coil pair; a coil impedance or a differential impedance of the two or more detection coils of the coil pair; a quality factor calculated as part of the object detection assessment; and an energy loss of a low power transmission of a primary coil of the Power Transmitter.

Clause 19. A method for wireless power transfer, including: receiving a communication from a Power Receiver present in a magnetic field of the Power Transmitter; obtaining a first measurement value of a first parameter of a low power transmission from a Power Transmitter during an object detection assessment; and calculating a coupling factor between the Power Transmitter and the Power Receiver based on the first measurement value, where the coupling factor represents an alignment of a primary coil of the Power Transmitter with a secondary coil of the Power Receiver.

Clause 20. The method of clause 19, further including: determining whether a foreign object is present with the Power Receiver in the magnetic field based on at least one of: the first measurement value, or a second measurement value of a second parameter obtained during the object detection assessment.

Clause 21. The method of clause 20, where determining whether the foreign object is present includes at least one of: determining that the foreign object is not present when the first measurement value or the second measurement value is outside a foreign object (FO) threshold range for foreign objects, or determining that the foreign object is not present when the first measurement value or the second measurement value is within a Power Receiver (PRx) threshold range based on a reference measurement value for the PRx.

Clause 22. The method of any one of clauses 19-21, where obtaining the measurement value includes: transmitting the low power signal while a power reception circuit of the Power Receiver is disabled, the low power signal having a first voltage at the primary coil; receiving a communication from the Power Receiver that indicates a second voltage at the power reception circuit caused by the low power signal; and calculating the coupling factor based, at least in part, on ratio of a second voltage and the first voltage.

Clause 23. An apparatus for wireless power transfer, including: a communication unit configured to receive a communication from a Power Receiver present in a magnetic field of the Power Transmitter; a measurement unit configured to obtain a measurement value based on an object detection assessment; and a control unit configured to determine whether a foreign object is present with the Power Receiver in the magnetic field based on the measurement value.

Clause 24. The apparatus of clause 23, where the control unit is configured to: determine that the foreign object is not present when the measurement value is outside a foreign object (FO) threshold range for foreign objects, or determine that the foreign object is not present when the measurement value is within a Power Receiver (PRx) threshold range based on a reference measurement value for the PRx.

Clause 25. The apparatus of clause 24, where the control unit is configured to: determine that the foreign object is present when the measurement value is outside the PRx threshold range, or determine that the foreign object is present when the measurement value is within the FO threshold range.

Clause 26. The apparatus of any one of clauses 24-25, where the PRx threshold range and the FO threshold range overlap each other, and where the control unit is configured to compare the measurement value with the PRx threshold range before comparing the measurement value with the FO threshold range.

Clause 27. The apparatus of any one of clauses 24-26, where the control unit is configured to: determine the PRx threshold range based on a fixed offset of a reference value for the Power Receiver.

Clause 28. The apparatus of any one of clauses 24-27, where the control unit is configured to: determine the PRx threshold range based on a previous measurement value of a previous object detection assessment in which the Power Transmitter confirmed that the foreign object is not present with the Power Receiver in the magnetic field.

Clause 29. The apparatus of clause 28, where the control unit is configured to: detect a user action after the previous object detection assessment when the previous object detection assessment is in the FO threshold range, where the user action is indicative that no foreign object is present in the magnetic field; store the previous measurement value as a reference value for the Power Receiver; and update the PRx threshold range based on the reference value.

Clause 30. The apparatus of clause 28, where the communication unit is configured to receive a communication from the Power Receiver after the previous object detection assessment when the previous object detection assessment is in the FO threshold range, where the communication is indicative that no foreign object is present in the magnetic field; and where the control unit is configured to: store the previous measurement value as the reference value for the Power Receiver; and update the PRx threshold range based on the reference value.

Clause 31. The apparatus of any one of clauses 24-30, where the communication unit is configured to receive a communication from the Power Receiver, the communication indicating the PRx threshold range for the Power Receiver, the PRx threshold range having been measured in a test environment when the Power Receiver was placed on a standard Power Transmitter with no foreign object present.

Clause 32. The apparatus of any one of clauses 24-31, where the communication unit is configured to receive a communication from the Power Receiver, the communication indicating a reference value for the Power Receiver; and where the control unit is configured to determine the PRx threshold range based on the reference value.

Clause 33. The apparatus of clause 31, where the reference value includes a reference measurement value having been measured in a test environment when the Power Receiver was placed on a standard Power Transmitter.

Clause 34. The apparatus of any one of clauses 24-33, where the communication unit is configured to receive a communication from the Power Receiver, the communication indicating that the Power Receiver contains friendly metals; and where the control unit is configured to determine the PRx threshold range based on a predetermined measurement value for Power Receivers that contain friendly metals.

Clause 35. The apparatus of any one of clauses 24-34, where the communication unit is configured to receive a communication from the Power Receiver, the communication indicating a range of expected measurement values for the Power Receiver; and where the control unit is configured to determine the PRx threshold range based on the range of expected measurement values.

Clause 36. The apparatus of any one of clauses 24-35, where the control unit is configured to obtain the PRx threshold range, or a reference value indicative of the PRx threshold range, or both, from a data field in an out-of-band communication received by the Power Transmitter from the Power Receiver.

Clause 37. The apparatus of clause 36, where the out-of-band communication is a near field communication (NFC) data exchange format (NDEF) message.

Clause 38. The apparatus of any one of clauses 23-33, where the control unit is configured to: enable a wireless power transfer mode of the Power Transmitter if the foreign object is not present with the Power Receiver; and disable the wireless power transfer mode of the Power Transmitter if the foreign object is present with the Power Receiver.

Clause 39. The apparatus of any one of clauses 24-38, where the control unit is configured to: calculate a coupling factor between the Power Transmitter and the Power Receiver based on the measurement value, where the coupling factor represents an alignment of a primary coil of the Power Transmitter with a secondary coil of the Power Receiver.

Clause 40. The apparatus of any one of clauses 23-39, where the measurement value is at least one value selected from a group consisting of: a coil voltage or a differential voltage of two or more detection coils of a coil pair; a coil current or a differential current of the two or more detection coils of the coil pair; a coil impedance or a differential impedance of the two or more detection coils of the coil pair; a quality factor calculated as part of the object detection assessment; and an energy loss of a low power transmission of a primary coil of the Power Transmitter.

Clause 41. An apparatus for wireless power transfer, including: a communication unit configured to receive a communication from a Power Receiver present in a magnetic field of the Power Transmitter; a measurement unit configured to obtain a first measurement value of a first parameter of a low power transmission from a Power Transmitter during an object detection assessment; and control unit is configured to calculate a coupling factor between the Power Transmitter and the Power Receiver based on the first measurement value, where the coupling factor represents an alignment of a primary coil of the Power Transmitter with a secondary coil of the Power Receiver.

Clause 42. The apparatus of clause 41, where the control unit is configured to: determine whether a foreign object is present with the Power Receiver in the magnetic field based on at least one of the first measurement value, or a second measurement value of a second parameter obtained during the object detection assessment.

Clause 43. The apparatus of clause 42, where the control unit is configured to: determine that the foreign object is not present when the first measurement value or the second measurement value is outside a foreign object (FO) threshold range for foreign objects, or determine that the foreign object is not present when the first measurement value or the second measurement value is within a Power Receiver (PRx) threshold range based on a reference measurement value for the PRx.

Clause 44. The apparatus of any one of clauses 41-43, where the control unit is configured to cause a primary coil or detection coil to transmit the low power signal while a power reception circuit of the Power Receiver is disabled, the low power signal having a first voltage at the primary coil; where the communication unit is configured to receive a communication from the Power Receiver that indicates a second voltage at the power reception circuit caused by the low power signal; and where the control unit is configured to calculate the coupling factor based, at least in part, on ratio of a second voltage and the first voltage.

Another innovative aspect of the subject matter described in this disclosure can be implemented as an apparatus. The apparatus may include a modem and at least one processor communicatively coupled with the at least one modem. The processor, in conjunction with the modem, may be configured to perform any one of the above-mentioned methods or features described herein.

Another innovative aspect of the subject matter described in this disclosure can be implemented as a computer-readable medium having stored therein instructions which, when executed by a processor, causes the processor to perform any one of the above-mentioned methods or features described herein.

Another innovative aspect of the subject matter described in this disclosure can be implemented as a system having means for implementing any one of the above-mentioned methods or features described herein.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, some aspects of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor-executable or computer-executable instructions encoded on one or more tangible processor-readable or computer-readable storage media for execution by, or to control the operation of, a data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method for wireless power transfer by a Power Transmitter, comprising:
receiving a communication from a Power Receiver present in a magnetic field of the Power Transmitter, the communication including a reference value having been obtained in a test object detection assessment when the Power Receiver was placed on a standard Power Transmitter with no foreign object present;
determining a Power Receiver (PRx) threshold range based, at least in part, on the communication;
obtaining a measurement value in an object detection assessment between the Power Transmitter and the Power Receiver; and
determining whether a foreign object is present with the Power Receiver in the magnetic field based on the measurement value and the PRx threshold range.

2. The method of claim 1, wherein determining whether the foreign object is present includes at least one of:
determining that the foreign object is not present when the measurement value is within the PRx; or
determining that the foreign object is present when the measurement value is outside the PRx threshold range.

3. The method of claim 1, wherein determining whether the foreign object is present further includes at least one of:
determining that the foreign object is not present when the measurement value is outside a foreign object (FO) threshold range for foreign objects, or
determining that the foreign object is present when the measurement value is within the FO threshold range.

4. The method of claim 3, further comprising:
comparing the measurement value to the PRx threshold range before comparing the measurement value to is compared with the FO threshold range.

5. The method of claim 1, further comprising:
determining the PRx threshold range based on a fixed offset of the reference value.

6. The method of claim 1, further comprising:
determining the PRx threshold range based on a previous measurement value of a previous object detection assessment in which the Power Transmitter confirmed that the foreign object is not present with the Power Receiver in the magnetic field.

7. (canceled)

8. The method of claim 1, further comprising:
obtaining a previous measurement value of a previous object detection assessment in which the foreign object is not present with the Power Receiver in the magnetic field;
receiving a communication from the Power Receiver after the previous object detection assessment, wherein the communication is indicative that no foreign object is present in the magnetic field; and
wherein the PRx threshold range is further based on the previous measurement value.

9. The method of claim 1
wherein the communication includes information indicating the PRx threshold range for the Power Receiver.

10-11. (canceled)

12. The method of claim 1, further comprising:
receiving a communication from the Power Receiver, the communication indicating that the Power Receiver contains friendly metals of conductive materials that are intentionally included to support functionality or construction of the Power Receiver; and
determining the PRx threshold range based on a predetermined measurement value for a reference Power Receiver that contains friendly metals.

13. The method of claim 1,
wherein the communication indicates a range of expected measurement values for the Power Receiver; and
wherein the PRx threshold range is further based on the range of expected measurement values.

14. The method of claim 1, wherein receiving the communication includes:
obtaining the PRx threshold range, or the reference value indicative of the PRx threshold range, or both, from a data field in an out-of-band communication received by the Power Transmitter from the Power Receiver.

15. (canceled)

16. The method of claim 1, further comprising:
enabling a wireless power transfer mode of the Power Transmitter if the foreign object is not present with the Power Receiver; and
disabling the wireless power transfer mode of the Power Transmitter if the foreign object is present with the Power Receiver.

17. The method of claim 1, further comprising:
calculating a coupling factor between the Power Transmitter and the Power Receiver based on the measurement value, wherein the coupling factor represents an alignment of a primary coil of the Power Transmitter with a secondary coil of the Power Receiver.

18. The method of claim 1, wherein the measurement value is at least one value selected from a group consisting of:
a coil voltage or a differential voltage of two or more detection coils of a coil pair;
a coil current or a differential current of the two or more detection coils of the coil pair;
a coil impedance or a differential impedance of the two or more detection coils of the coil pair;
a quality factor calculated as part of the object detection assessment; and
an energy loss of a low power transmission of a primary coil of the Power Transmitter.

19. The method of claim 1, further comprising:
obtaining a first measurement value during an initial object detection assessment;
determining the PRx threshold range based, at least in part, on the reference value and the first measurement value;
obtaining a second measurement value during a subsequent object detection assessment; and
detecting the foreign object when the second measurement value is outside the PRx threshold range.

20-22. (canceled)

23. An apparatus for wireless power transfer, comprising:
a communication unit to receive a communication from a Power Receiver present in a magnetic field of a Power Transmitter, the communication including a reference value having been obtained in a test object detection assessment when the Power Receiver was placed on a standard Power Transmitter with no foreign object present;
a measurement unit to obtain a measurement value in an object detection assessment between the Power Transmitter and the Power Receiver; and
a control unit configured to:
determine a Power Receiver (PRx) threshold range based, at least in part, on the communication, and
determine whether a foreign object is present with the Power Receiver in the magnetic field based on the measurement value and the PRx threshold range.

24. The apparatus of claim 23, wherein the control unit is configured to:
determine that the foreign object is not present when the measurement value is within the PRx threshold range; or
determine that the foreign object is present when the measurement value is outside the PRx threshold range.

25. The apparatus of claim 24, wherein the control unit is configured to:
determine that the foreign object is not present when the measurement value is outside a foreign object (FO) threshold range for foreign objects; or
determine that the foreign object is present when the measurement value is within the FO threshold range.

26. The apparatus of claim 25, wherein the control unit is configured to;
compare the measurement value to the PRx threshold range before comparing the measurement value to the FO threshold range.

27. The apparatus of claim 23, wherein the control unit is configured to:
determine the PRx threshold range based on a fixed offset of the reference value.

28. The apparatus of claim 23, wherein the control unit is configured to:
determine the PRx threshold range based on a previous measurement value of a previous object detection assessment in which the Power Transmitter confirmed that the foreign object is not present with the Power Receiver in the magnetic field.

29. The apparatus of claim 23, wherein the control unit is configured to:
obtain a previous measurement value of a previous object detection assessment in which the foreign object is not present with the Power Receiver in the magnetic field;
receive, via the communication unit, a communication from the Power Receiver after the previous object detection assessment, wherein the communication is indicative that no foreign object is present in the magnetic field; and
wherein the PRx threshold range is further based on the previous measurement value.

30. The apparatus of claim 23,
wherein the control unit is configured to obtain a previous measurement value of a previous object detection assessment in which the foreign object is not present with the Power Receiver in the magnetic field;
wherein the communication unit is configured to receive a communication from the Power Receiver after the previous object detection assessment, wherein the communication is indicative that no foreign object is present in the magnetic field; and
wherein the PRx threshold range is further based on the previous measurement value.

31. The apparatus of claim 23,
wherein the communication includes information indicating the PRx threshold range for the Power Receiver.

32-33. (canceled)

34. The apparatus of claim 23,
wherein the communication unit is configured to receive a communication from the Power Receiver, the communication indicating that the Power Receiver contains friendly metals of conductive materials that are intentionally included to support functionality or construction of the Power Receiver; and
wherein the control unit is configured to determine the PRx threshold range based on a predetermined measurement value for a reference Power Receiver that contains friendly metals.

35. (canceled)

36. The apparatus of claim 24, wherein the control unit is configured to obtain the PRx threshold range, or a reference value indicative of the PRx threshold range, or both, from a data field in an out-of-band communication received by the Power Transmitter from the Power Receiver.

37. (canceled)

38. The apparatus of claim 23, wherein the control unit is configured to:
enable a wireless power transfer mode of the Power Transmitter if the foreign object is not present with the Power Receiver; and
disable the wireless power transfer mode of the Power Transmitter if the foreign object is present with the Power Receiver.

39. The apparatus of claim 24, wherein the control unit is configured to:
calculate a coupling factor between the Power Transmitter and the Power Receiver based on the measurement value, wherein the coupling factor represents an alignment of a primary coil of the Power Transmitter with a secondary coil of the Power Receiver.

40. The apparatus of claim 23, wherein the measurement value is at least one value selected from a group consisting of:
a coil voltage or differential voltage of two or more detection coils of a coil pair;
a current of a coil or differential current of the two or more detection coils of the coil pair;
a coil impedance or differential impedance of the two or more detection coils of the coil pair;
a quality factor calculated as part of the object detection assessment t; and
an energy loss of a low power transmission of a primary coil of the Power Transmitter.

41-44. (canceled)
